(19) United States
(12) Patent Application Publication
(10) Pub. No.: US 2014/0231358 A1
(43) Pub. Date: Aug. 21, 2014

(54) MAGNETIC SEPARATOR, METHOD FOR OPERATION THEREOF AND USE THEREOF

(71) Applicants: Argun Gökpekin, Hammelburg (DE); Ralph Oliver Schmidt, Fürth (DE)

(72) Inventors: Argun Gökpekin, Hammelburg (DE); Ralph Oliver Schmidt, Fürth (DE)

(73) Assignee: SIEMENS AKTIENGESELLSCHAFT, Munich (DE)

(21) Appl. No.: 14/347,839

(22) PCT Filed: Sep. 4, 2012
(86) PCT No.: PCT/EP2012/067203

§ 371 Date: Mar. 27, 2014

(30) Foreign Application Priority Data
Sep. 27, 2011 (EP) 11182927

(51) Int. Cl. B03C 1/14

(52) U.S. Cl. CPC B03C 1/145
USPC 210/695; 210/143; 210/96.1; 210/97

(57) ABSTRACT

A magnetic separator separates magnetic and/or magnetisable particles from a fluid with a rotatable drum, at least one magnet arrangement arranged in an interior of the drum and a separation zone through which the fluid can be conducted. The separation zone is formed by an interspace between the drum and a fluid conduction arrangement. It is possible to modify at least locally a distance between the drum and the fluid conduction arrangement and/or a width of the separation zone during the operation of the magnetic separator. A measuring apparatus captures at least one fluid parameter of the fluid. The distance and/or the width can be modified dependent on the at least one fluid parameter. A method operates such a magnetic separator.

### CROSS REFERENCE TO RELATED APPLICATIONS

This application is based on and hereby claims priority to International Application No. PCT/EP2012/067203 filed on Sep. 4, 2012 and European Application No. 11182927.1 filed on Sep. 27, 2011, the contents of which are hereby incorporated by reference.

### BACKGROUND

The invention relates to a magnetic separator for separating magnetic and/or magnetizable particles from a fluid, the magnetic separator having a rotatable drum, a magnet, and a separation zone through which the fluid can be conducted, wherein the separation zone is between the drum and a fluid conduction arrangement.

The invention further relates to a method for operating such a magnetic separator.

Magnetic separators of the type cited in the introduction are already known. They are used in the mining industry and the metal industry in particular, but also in other branches of industry. For example, RU 2365421 C1 describes a magnetic separator of the type in question having a drum and a magnet arrangement, which is designed to rotate about the axis of the drum and comprises permanent magnets, for wet separation.

Most existing design formats of magnetic separators with drums, also known as drum separators, and particularly weak-field magnetic separators for the wet processing of strongly magnetic iron ores in particular, work according to the principle of siphon separation. If the fluid to be separated contains fine or extra-fine grains, the drag forces of the fluid cannot be ignored in the case of wet separation. Assuming that the fluid flows through the separation zone at an average speed V₀ and the magnetic force is constant over a length I of the separation zone, the following equilibrium of forces is produced in the vertical for each grain:

F_{M-}F_{G}+F_{A}−F_{W}−F_{T}=0
where
F_{M}=magnetic force
F_{G}=gravitational force
F_{A}=static buoyancy
F_{w}=drag force
F_{T}=inertial force.

In the mining industry in particular, increasing comminution of the rock to be separated (some particle diameters being in the low two-digit micrometer range) and the consequently growing quantity of fine particles in the fluid mean that said particles are not pulled towards the drum wall if they are situated in the region of the fluid conduction arrangement and hence in the separation zone furthest from the drum. A magnetic field of only limited strength and limited flux density gradient acts at this location, and is often no longer sufficient to influence the position of the magnetic and/or magnetizable fine or extra-fine particles in the fluid. Therefore a considerable portion of magnetic and/or magnetizable particles cannot be separated.

Inhomogeneities in the composition of the rock or mineral being mined at the workface can result in changes to the grain size distribution and mineral composition of the particles contained in the fluid. This routinely results in a requirement for the separation process and the machine parameters of the magnetic separator to be adapted to the changed properties of the fluid, in order to ensure a consistently high quality of the separation process. In the case of short-term fluctuations or a rapid succession of fluctuations in the rock or mineral composition, it is sometimes not possible to maintain the quality of the separation process, since the change in machine parameters is normally associated with a machine stoppage which cannot be justified for every short-term fluctuation of the fluid. Magnetic and/or magnetizable particles are therefore lost and the yield of the separation process is reduced.

A further effect occurs during the wet separation of strongly magnetic particles, e.g. iron ore, in that flakes form in the separation zone due to an agglomeration of magnetic particles, and said flakes enclose or include non-magnetic, non-magnetizable, or weakly magnetic or weakly magnetizable particles and carry them away at the same time. As a component part of the flakes, these enclosed particles arrive in the separated concentrate of the valuable substance, which ideally should predominantly comprise only magnetic and/or magnetizable particles having a valuable substance proportion greater than 55% by weight, and therefore reduce the quality thereof.

The above cited RU 2365421 C1 attempts to alleviate this problem by deflection plates which are permanently installed at regular intervals in the separation zone, and which continuously direct a liquid medium flowing through the separation zone towards the drum wall. As a result, fine and extra-fine magnetic particles are repeatedly directed towards the drum, the distance is reduced between the drum and fine and extra-fine particles flowing in the fluid in the region of the fluid conduction arrangement, and a formation of flakes is made slightly more difficult. If the composition of the fluid is largely constant, this design of the magnetic separator allows a high yield to be achieved even if there is a large proportion of fine or extra-fine particles.

A rapid response to changing rock or mineral compositions and grain size distributions in the fluid that is to be separated can only be achieved by adapting the rotational frequency of the magnet arrangement about the drum axis. The amount of influence is limited, however, and therefore a change in the machine parameters is nonetheless usually required in such cases, wherein the magnetic separator must then be stopped or shut down.

### SUMMARY

One possible object is therefore to provide an improved magnetic separator and a method for the operation thereof, by which the yield of the separation process can be further increased.

The inventors propose a magnetic separator for separating magnetic and/or magnetizable particles from a fluid which also contains non-magnetic and/or non-magnetizable particles, said magnetic separator having a rotatable drum, at least one magnet arrangement arranged in an interior of the drum, and a separation zone through which the fluid can be conducted, said separation zone being formed by an interspace between the drum and a fluid conduction arrangement, a distance between the drum and the fluid conduction arrangement and/or a width of the separation zone can be modified at least locally during operation of the magnetic separator, wherein at least one measuring apparatus is provided for capturing at least one fluid parameter of the fluid and the distance and/or the width can be modified as a function of the at least one fluid parameter.

“Operation” of the magnetic separator occurs whenever fluid flows through the separation zone. In particular, the operation of the magnetic separator implies a rotational movement of the drum.

By virtue of the change which is now possible in the geometry of the separation zone during the live operation of the magnetic separator, when fluid is conducted through the separation zone and the drum has been set into rotation, it is readily possible to adapt quickly to the properties of the fluid. This improves the yield of magnetic and/or magnetizable particles, even in the context of short-term and frequently changing fluid properties, and reduces plant downtimes such that the overall productivity increases.

A change in the distance A between drum and fluid conduction arrangement and/or a change in a width B of the separation zone is synonymous with an at least local change in the cross section of the separation zone viewed in a flow direction of the fluid. The cross section of the separation zone viewed in a longitudinal direction of the separation zone, i.e. from the entry point of the fluid into the separation zone to the exit point of the fluid from the separation zone, can be decreased or increased at any desired location in this case. Furthermore, specific flow patterns of the fluid can be set within the separation zone, such that the fluid is conducted through the separation zone in an essentially meandering or wave-like manner, for example.

In this case, the cross-sectional area of the separation zone viewed in a flow direction of the fluid can normally be modified by at least 5%, in particular by at least 10%. A distance between the drum and the fluid conduction arrangement and/or a width of the separation zone can be reduced in particular by at least 10%, in particular by at least 25%.

The at least one magnet arrangement in the drum can be so configured as to be fixed or movable. Permanent magnets and/or electromagnets can be used in the magnet arrangement in this case.

During operation of the magnetic separator, the drum rotates e.g. in the direction of the fluid flow, wherein a drum drive may be provided or the drum may be driven by the flowing fluid in a similar manner to a water wheel. Such magnetic separators are known as synchronous separators.

Alternatively, designs of magnetic separators are also known in which the drum moves against the fluid flow, or moves against the fluid flow at least in sections of the separation zone. These are known as counterflow separators or semicounterflow separators.

The fluid can be a particle-charged gas or a suspension, the latter being preferred here.

In a particularly satisfactory embodiment, the fluid conduction arrangement comprises at least one flow directing device, which can be moved by at least one drive device and can be moved into the separation zone, in particular towards the drum. By virtue of a flow directing device being movable towards the drum, the distance A between the drum and the fluid deflection device can be changed generally or in specific regions as required, being reduced in particular here.

However, such a flow directing device can also be moved in a direction that is parallel to the drum surface in the separation zone, in order to modify the width B of the separation zone generally or locally. Since this can take place during the operation of the magnetic separator, it is possible to adapt the geometry of the separation zone to fluctuations in the fluid composition without stopping the plant. The maximal separation effect can therefore be optimally set at all times.

In addition, the magnetic separator preferably has a control device to which the at least one captured fluid parameter can be sent, and which is so configured as to send a control signal to the at least one drive device for the purpose of positioning the at least one flow directing device as a function of the at least one fluid parameter. Such a control device allows the geometry of the separation zone to be adapted to fluctuations in the fluid composition automatically and hence in a particularly rapid and effective manner.

In a particularly preferred embodiment, viewed along a drum axis of the drum, an angular range a in which the distance between the drum and the fluid conduction arrangement and/or a width of the separation zone can be modified at least locally is greater than 35° of a circumference of the drum. In particular, the angular range a is greater than 40°, preferably greater than 60° of a circumference of the drum. However, an angular range a is most preferably in the region of 180° to 320° of a circumference of the drum. The scope for influencing the fluid is thereby improved and the probability clearly increased that the intended measure will be completed successfully.

The at least one flow directing device is preferably designed in the form of a panel, flap, deflector plate or male form. The selective use of such flow directing devices allows the flow in the separation zone to be selectively influenced, creating regions of laminar flow and regions of turbulent flow, e.g. containing eddy currents, reverse currents, etc.

In a preferred embodiment of the magnetic separator, the fluid conduction arrangement comprises a deformable membrane on at least parts of its surface facing the separation zone. In this case, the drive device(s) are situated on a side of the membrane facing away from the separation zone, and in particular from the at least one flow directing device. Such a membrane is formed by e.g. a wear-resistant film of plastic and/or metal which is impermeable to the fluid. The membrane reliably prevents any escape of fluid from the separation zone and any contamination of the mechanism of the movable flow directing device(s). Blockage of the movable flow directing device(s) due to particles from the fluid, in particular the suspension, and any corrosive effect on the surfaces of the flow directing device(s) and/or their drives(s) can be prevented thereby.

The at least one drive device of a flow directing device is preferably a motorized, pneumatic, hydraulic or mechanical drive device. A mechanical drive device in this case is understood to be e.g. a connecting rod, crank arrangement or the like, which allows manual adjustment of the position of one or more flow directing devices simultaneously. A pneumatic drive device is e.g. an adjustment system that is operated by compressed air. An electromotive drive device comprising at least one electric motor is however particularly preferred.

The at least one measuring apparatus for capturing at least one fluid parameter of the fluid can be arranged before an inlet into the separation zone and/or in the separation zone and/or after an exit from the separation zone. In particular, at least one of the following fluid parameters can be captured by such a measuring apparatus:

Before or at the inlet of the fluid into the separation zone:
particle size and/or particle size distribution of the particles in the fluid;
flow speed of the fluid;
flow rate of the fluid (volume-based or mass-based measurement);
solid content of the fluid.

In the separation zone:
flow speed of the fluid;
flow rate of the fluid.

At the outlet of the fluid from the separation zone or after the separation zone:
content of the material stream separated from the fluid, also known as concentrate stream, in terms of magnetic and/or magnetizable particles;
content of the concentrate stream separated from the fluid, in terms of non-magnetic and/or non-magnetizable particles;
content of the residual fluid, also known as waste stream, in terms of magnetic and/or magnetizable particles;
content of the waste stream in terms of non-magnetic and/or non-magnetizable particles;
particle size and/or particle size distribution of the particles in the separated concentrate stream;
particle size and/or particle size distribution of the particles in the waste stream;
flow rate of the concentrate stream (volume-based or mass-based measurement);
solid content of the concentrate stream.

For example, a measuring apparatus can be used to perform an X-ray fluorescence analysis for determining the composition and/or concentration of substances in the fluid, a laser diffraction for measuring particle size distribution or particle sizes, an ultrasound measurement for measuring particle size distribution or particle sizes, an ultrasound measurement for determining a concentration of solids in the fluid, or a Coriolis mass-flow measurement for determining the current flow of fluid.

The inventors also propose a method for operating a magnetic separator, in that a fluid comprising magnetic and/or magnetizable particles and also non-magnetic and/or non-magnetizable particles is conducted through the separation zone, in that the magnetic and/or magnetizable particles accumulate predominantly at the drum which has been set into rotation and are separated from the fluid, in that a distance between the drum and the fluid conduction arrangement and/or the width B of the separation zone is modified at least once at least locally during the operation of the magnetic separator, and in that at least one fluid parameter of the fluid is captured by the at least one measuring apparatus and the distance and/or the width is modified as a function of the at least one fluid parameter.

The change in the geometry of the separation zone makes it possible to influence the flow speed of the fluid, the type of flow of the fluid, and the path taken by the flow within the separation zone. The separation process can therefore be optimally adapted to changing fluid properties. The separation quality is improved and the yield is increased. It is possible to avoid machine downtimes during modifications that are required to the geometry of the separation zone.

The distance A between the drum and the fluid conduction arrangement or the width B of the separation zone is preferably modified by modifying a position of the at least one flow directing device by the at least one drive device. A flow directing device can be moved in a straight line, diagonally, or on a circular path in this case.

The capture of at least one fluid parameter of the fluid is effected by the at least one measuring apparatus, wherein the distance A and/or the width B is modified as a function of the at least one fluid parameter. In particular, this means that the geometry of the separation zone is changed automatically as a function of fluid parameters that are measured online. In this case, the distance A and/or the width B are controlled automatically as a function of the at least one fluid parameter.

In particular, it is useful if the distance between the drum and the fluid conduction arrangement is continuously modified, i.e. the at least one flow directing device is made to oscillate by the at least one drive device. This results in a pulsation of the fluid, thereby preventing any formation of flakes of agglomerated magnetic particles and/or dispersing any existing flakes.

In particular, an oscillation frequency and/or an oscillation amplitude and/or a temporal sequence of different oscillation frequencies and/or a temporal sequence of different oscillation amplitudes are set as a function of at least one measured fluid parameter. For example, if a proportion of non-magnetic and/or non-magnetizable particles increases in the separated material stream, also known as concentrate stream, an oscillation frequency and/or oscillation amplitude is increased in order to break up any increased formation of flakes.

In order to direct as many magnetic and/or magnetizable particles as possible towards the drum and at the same time to prevent as far as possible a formation of flakes, provision is preferably made for generating a predominantly turbulent flow of the fluid in the separation zone.

In particular, it is useful if the fluid conducted through the separation zone is a suspension, such that wet separation takes place.

Use of a magnetic separator for the purpose of separating magnetic and/or magnetizable particles of ore from non-magnetic and/or non-magnetizable particles of gangue has proven particularly satisfactory.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 shows a first magnetic separator;

FIG. 2 shows a cross section through the first magnetic separator;

FIG. 3 shows the fluid conduction arrangement of the first magnetic separator;

FIG. 4 shows a second magnetic separator in cross section;

FIG. 5 shows a third magnetic separator;

FIG. 6 shows the third magnetic separator in cross section;

FIG. 7 shows a first fluid conduction arrangement of the third magnetic separator;

FIG. 8 shows a second fluid conduction arrangement of the third magnetic separator;

FIG. 9 shows a schematic illustration of a preferred operation of a magnetic separator;

FIG. 10 shows a further schematic illustration of a preferred operation of a magnetic separator;

FIG. 11 shows a further schematic illustration of a preferred operation of a magnetic separator; and

FIG. 12 shows a further schematic illustration of a preferred operation of a magnetic separator.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

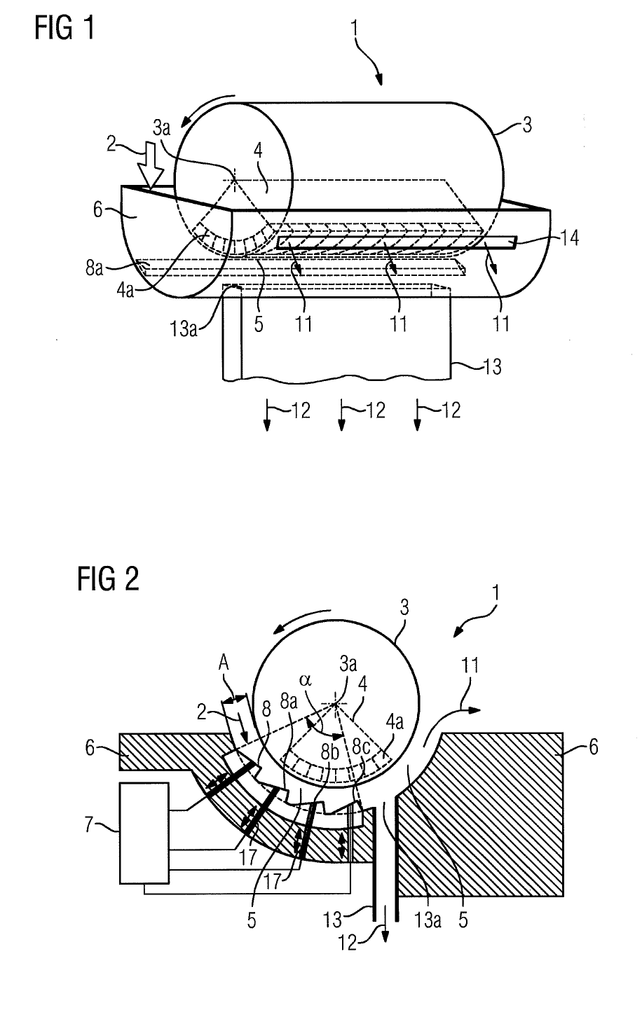

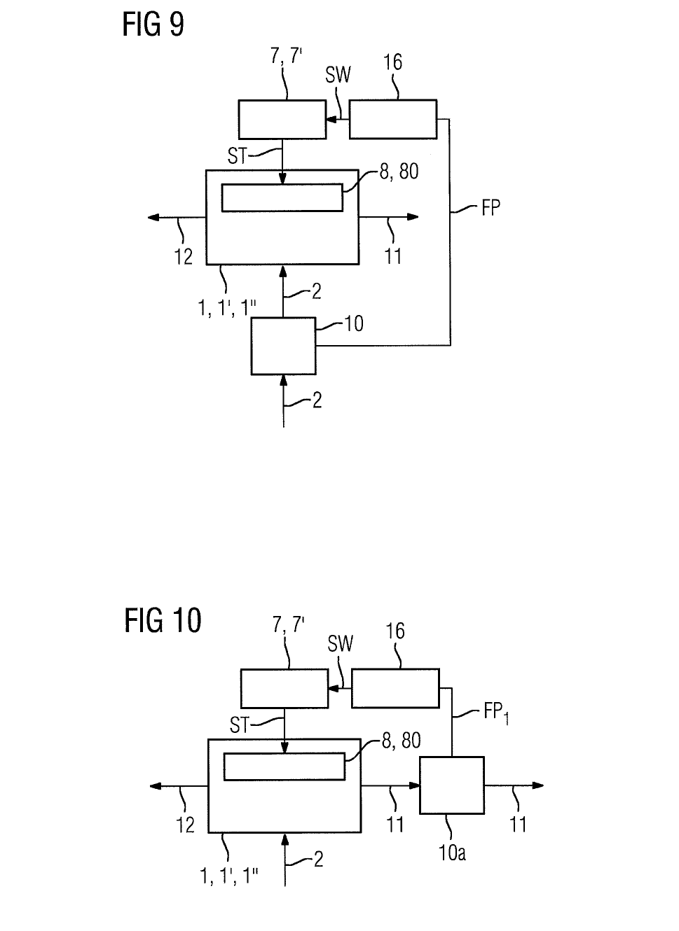

Illustrations of the at least one measuring apparatus 10,10a,10b of the magnetic separator (for capturing at least one fluid parameter of the fluid 2) and of the optional control device 16 are omitted from the FIGS. 1 to 8 in order to allow greater clarity; see FIGS. 9 to 12, however.

FIG. 1 shows a first magnetic separator 1 in a three-dimensional view. The magnetic separator 1 is used to separate magnetic and/or magnetizable particles from a fluid 2 which further comprises non-magnetic and/or non-magnetizable particles. Provision is made for a drum 3 which can rotate about a drum axis 3a, and for a magnet arrangement 4 which comprises permanent magnets 4a and is permanently arranged in an interior of the drum 3. Alternatively, however, the magnet arrangement 4 can also be rotatable about the drum axis 3a. A separation zone 5 through which the fluid 2 can be conducted is formed by an interspace between the drum 3 and a fluid conduction arrangement 6. A distance A (cf. FIG. 2) between the drum 3 and the fluid conduction arrangement 6 can be modified here during operation of the magnetic separator 1. The fluid conduction arrangement 6 here comprises a plurality of flap-shaped flow directing devices 8,8a,8b,8c which can be moved by at least one drive device 7 inwards into the separation zone 5 and towards the drum 3. The drum 3 rotates in the direction of the flow direction of the fluid 2, magnetic particles being drawn into the vicinity of the drum 3 and non-magnetic particles remaining in the region of the fluid conduction arrangement 6. A waste stream 12 comprising predominantly non-magnetic and/or non-magnetizable particles is drained out of the separation zone 5 via an outlet 13a and carried away via a drain connector 13. A concentrate stream 11 comprising predominantly magnetic and/or magnetizable particles is drained off via a concentrate outlet 14 which, in the direction of rotation of the drum 3, is situated after the outlet 13a for the waste stream in the fluid conduction arrangement 6. Though omitted here for the sake of clarity, scrapers, spray mist or similar can be used here to separate the concentrate stream 11 from the drum 3. The manner in which a change is effected in the geometry of the separation zone 5 can be seen in FIG. 2.

FIG. 2 shows a cross section through the first magnetic separator 1 as per FIG. 1. Reference signs identical to those in FIG. 1 designate identical elements. The position of the flap-shaped flow directing devices 8,8a,8b,8c is modified by actuating elements 17 which are driven via a drive device 7. In this case, the actuating elements 17 can be positioned manually, e.g. via connecting rods or cranks with spindle propulsion. However, the actuating elements 17 are preferably positioned automatically by e.g. electric motors, etc. as a function of measured fluid parameters of the fluid 2. Viewed along the drum axis 3a, an angular range α in which the distance between the drum 3 and the fluid conduction arrangement 6 can be modified is greater than 35° of a circumference of the drum 3 in this case.

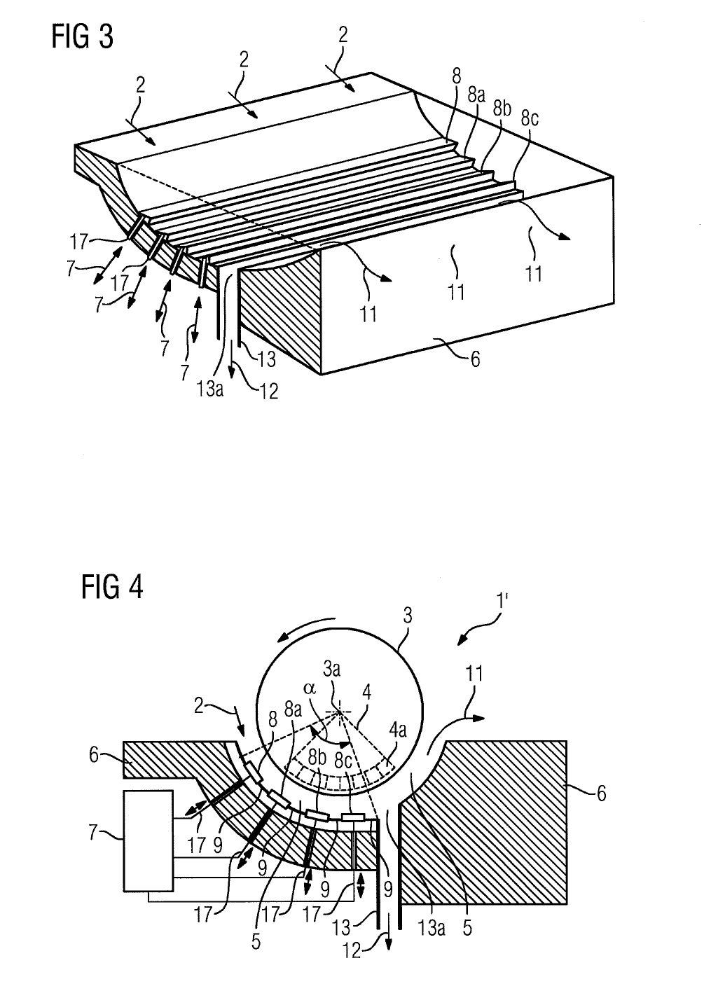

For greater clarity, FIG. 3 shows the fluid conduction arrangement 6 of the first magnetic separator 1 without the drum 3 in a three-dimensional view. Reference signs identical to those in FIG. 2 designate identical elements. Shading is used to emphasize the largely perpendicularly projecting surfaces of the flow directing devices 8,8a,8b,8c, which repeatedly direct the fluid 2 towards the drum 3 in order to improve the separation of the magnetic and/or magnetizable particles contained therein as it passes through the separation zone 5 (cf. FIG. 2). The gradient of the flow directing devices 8,8a,8b,8c influences the acceleration of the magnetic and/or magnetizable particles towards the drum 3. In this view, it can be seen that the flow directing devices 8,8a,8b,8c extend over the entire width of the separation zone 5 or fluid conduction arrangement 6. Alternatively, however, individual and separately positionable flow directing devices can also be so arranged as to be distributed next to each over the width of the fluid conduction arrangement 6, being separated by a gap or closely adjacent. The separation process can be optimized by adjusting the position of the flow directing devices 8,8a,8b,8c.

FIG. 4 shows a second magnetic separator 1′ in cross section, differing from the first magnetic separator 1 as per FIGS. 2 and 3 in respect of the flow directing devices 8,8a,8b,8c in particular. Reference signs identical to those in FIG. 2 designate identical elements. Provision is made here for panel-shaped flow directing devices 8,8a,8b,8c which are connected together by a flexible membrane 9 and therefore movable. The actuating elements 17 are connected to the panel-shaped flow directing devices 8,8a,8b,8c in an articulated manner and are driven via a drive device 7. The positioning of the flow directing devices 8,8a,8b,8c is effected by setting the position of the actuating elements 17, wherein the positioning of one flow directing device is dependent on the adjacently disposed flow directing device(s) in this case. In this case, viewed along the drum axis 3a, an angular range a in which the distance between the drum 3 and the fluid conduction arrangement 6 can be modified is greater than 35° of a circumference of the drum 3. As shown in FIG. 3, the panel-shaped flow directing devices 8,8a,8b,8c here can likewise extend over the entire width of the separation zone 5 or fluid conduction arrangement 6. Alternatively, however, individual and separately positionable panel-shaped flow directing devices can also be so arranged as to be distributed next to each over the width of the fluid conduction arrangement 6, being separated by a gap or closely adjacent. The connection between the individual panel-shaped flow directing devices is always formed by the flexible membrane in this case.

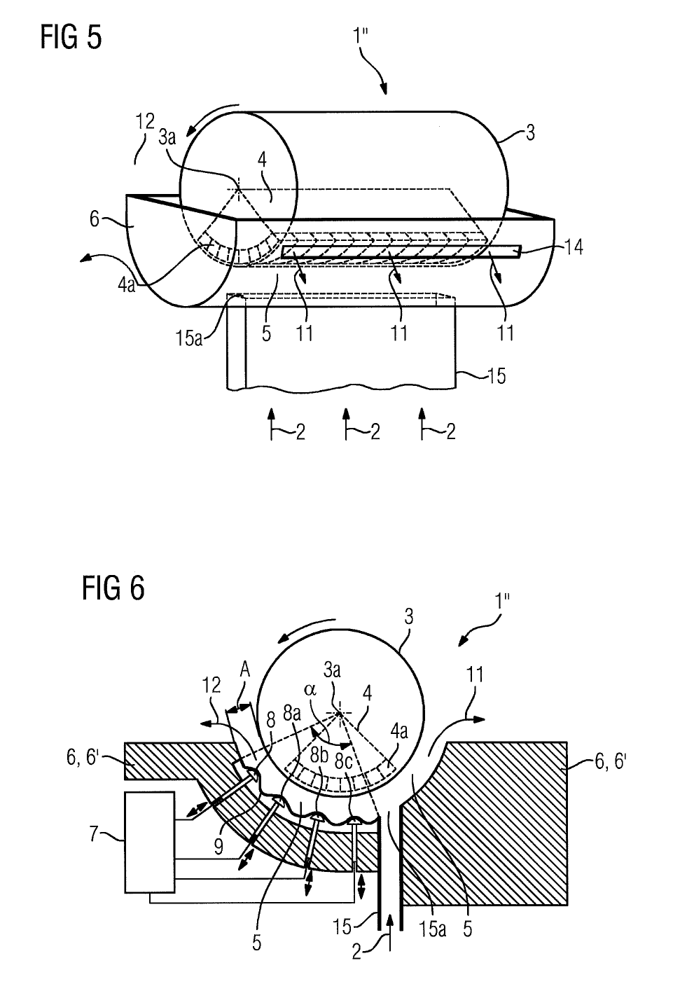

FIG. 5 shows a three-dimensional view of a third magnetic separator 1″ having a different flow path of the fluid 2. Reference signs identical to those in FIG. 1 designate identical elements. In this case, the fluid 2 is introduced into the separation zone 5 from below via a fluid supply connector 15. This is effected via a fluid inlet 15a in the fluid conduction arrangement 6. The magnetic and/or magnetizable particles are drained off in the region of a concentrate outlet 14 with the concentrate stream 11, which flows in the direction of the drum movement, while the non-magnetic and/or non-magnetizable particles are removed with the waste stream 12, which flows against the drum movement. Though omitted here for the sake of clarity, scrapers, spray mist or similar may be used here to separate the concentrate stream 11 from the drum 3.

FIG. 6 shows the third magnetic separator 1″ in cross section. Reference signs identical to those in FIG. 5 designate identical elements. Provision is made here for flow directing devices 8,8a,8b,8c which are mushroom-shaped when viewed in cross section and are covered by a continuous flexible membrane 9 that seals the separation zone 5 from below. The flow directing devices 8,8a,8b,8c are pneumatically driven via a drive device 7 in this case. The positioning of the flow directing devices 8,8a,8b,8c is effected by setting an air pressure below the flow directing devices 8,8a,8b,8c, wherein the positioning of the membrane 9 in regions that are not supported by the flow directing devices 8,8a,8b,8c is dependent on the position or positions of the adjacently disposed flow directing devices in this case.

Alternatively, the membrane 9 can also be deflected towards the drum 3 by a flow directing device in the form of an air cushion which is generated beneath the membrane 9, wherein the mushroom-shaped flow directing device can then be omitted.

Viewed along the drum axis 3a, an angular range a in which the distance between the drum 3 and the fluid conduction arrangement 6, 6′ can be modified is greater than 35° of a circumference of the drum 3 in this case.

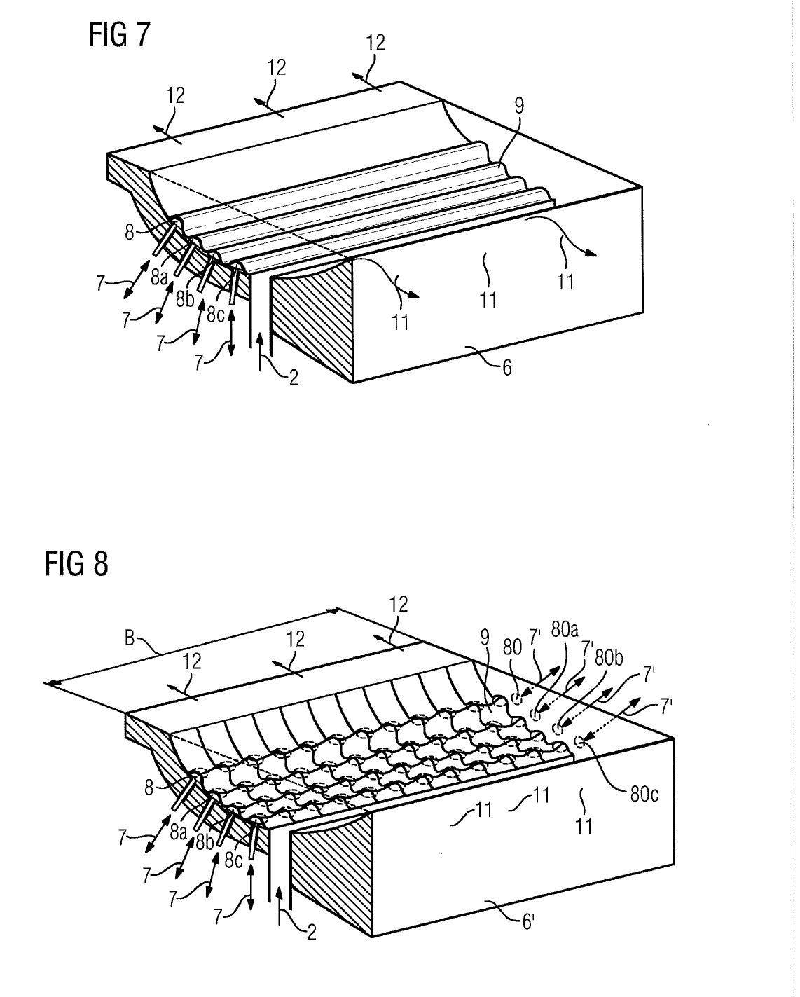

For greater clarity, FIG. 7 shows a first fluid conduction arrangement 6 of the third magnetic separator 1″ in plan view without the drum 3 in a three-dimensional view. Reference signs identical to those in FIG. 6 designate identical elements. The flow directing devices 8,8a,8b,8c are seen to be mushroom-shaped in cross section, and repeatedly direct the fluid 2 towards the drum 3 in order to improve the separation of the magnetic and/or magnetizable particles contained therein as it flows through the separation zone 5 (cf. FIG. 6). It can be seen in this view that the flow directing devices 8,8a,8b,8c extend linearly over the entire width of the separation zone 5 or first fluid conduction arrangement 6. The fluid 2 flows through the separation zone 5 in an essentially wavelike manner here.

FIG. 8 shows an alternative second fluid conduction arrangement 6′ of the third magnetic separator 1″. In this case, individual and separately positionable mushroom-shaped flow directing devices are so arranged as to be distributed next to each other over the width of the fluid conduction arrangement 6′, being separated by a gap or closely adjacent. In addition to a wave structure along the separation zone 5 as shown in FIG. 7, a further wave structure can be developed over the width of the separation zone 5 here, such that a clearly differentiated flow pattern of the fluid 2 can be achieved by locally changing the distance A between drum 3 and second fluid conduction arrangement 6′.

The second fluid conduction arrangement 6′ has further flow directing devices 80,80a,80b,80c, which are arranged laterally on the second fluid conduction arrangement 6′ and so configured as to modify the width B of the separation zone 5 (cf. FIG. 8). For greater clarity, the further flow directing devices 80,80a,80b,80c are only shown on one side of the fluid conduction arrangement 6′, but may be present on either of the two sides or on both sides. The further flow directing devices 80,80a,80b,80c, by which the width B of the separation zone can be modified locally, are constructed in a similar manner to the flow directing devices 8,8a,8b,8c and are covered by a membrane, in particular also by the membrane 9. However, the further flow directing devices 80,80a,80b,80c can also differ in design from the flow directing devices 8,8a,8b,8c which are used to modify the distance A between the drum and the fluid conduction arrangement 6′.

The positioning of the further flow directing devices 80,80a,80b,80c is effected by a further drive device 7′. In particular, the second fluid conduction arrangement 6′ here is so operated as to continuously modify the position of the flow directing devices 8,8a,8b,8c and/or further flow directing devices 80,80a,80b,80c, thereby causing these to oscillate. This results in a pulsation of the fluid 2, which is accompanied by an increased breakdown of flakes of agglomerated magnetic and/or magnetizable particles in the fluid 2. The separation performance is improved since fewer non-magnetic and/or non-magnetizable particles contained in some flakes enter the concentrate stream 11.

FIG. 9 shows a schematic illustration of a preferred operation of a magnetic separator 1,1′,1″ comprising one or more flow directing devices 8,80. The fluid 2 that is to be introduced into the separation zone 5 of the magnetic separator 1,1′,1″, in particular in the form of a suspension, is analyzed by a first measuring apparatus 10, in particular in respect of at least one fluid parameter FP from the group comprising:
a particle size and/or particle size distribution of the particles in the fluid 2,
a flow speed of the fluid 2,
a flow rate of the fluid 2 (volume-based or mass-based measurement),
a solid content of the fluid 2.

The fluid parameter FP is transferred to a control device 16, which sends a control signal SW to the at least one drive unit 7,7′ as a function of the fluid parameter FP. The drive unit 7,7′ then effects a positioning of the at least one flow directing device 8,80 as a function of the measured fluid parameter(s) FP, wherein a corresponding setting value ST is prescribed for the at least one flow directing device 8,80.

If e.g. the particle size distribution of the particles in the fluid 2 is captured as a fluid parameter, the distance A between drum and fluid conduction arrangement is reduced in the event that the particle sizes change to smaller particles. If a change in the particle size to bigger particles in the fluid 2 is measured, the distance A between drum and fluid conduction arrangement is increased. This preferably takes place automatically. This ensures that the optimal separation performance can be maintained even in the context of changing fluid parameters FP, without having to turn off the magnetic separator 1,1′,1″.

If e.g. the flow speed of the fluid 2 is captured as fluid parameter FP, the distance A between drum and fluid conduction arrangement is reduced in the event that the flow speed increases, and conversely is increased if the flow speed decreases. This preferably takes place automatically.

If e.g. a flow rate of the fluid 2 (volume-based or mass-based measurement) is captured as fluid parameter FP, in particular the distance A between drum and fluid conduction arrangement is increased in the event that the flow rate increases, and conversely is reduced if the flow rate decreases. This preferably takes place automatically.

If e.g. a solid content of the fluid 2 is captured as fluid parameter FP, in particular the distance A between drum and fluid conduction arrangement and/or the width of the separation zone is increased in the event that the solid content increases. The fluid is also made to oscillate if applicable, wherein a dynamic change in the distance A and/or the width B then occurs, in order to break up any flakes that may be present. Conversely, the distance A is preferably decreased if the solid content decreases. This preferably takes place automatically.

If a plurality of fluid parameters FP are captured, these can interact with each other and provision must be made in the control device 16 for a suitable control algorithm which evaluates the fluid parameters FP accordingly and automatically calculates the optimal positioning of the at least one flow directing device. Such a control algorithm can readily be produced on the basis of a few test runs.

FIG. 10 shows a further schematic illustration of a preferred operation of a magnetic separator 1,1′,1″ comprising one or more flow directing devices 8,80. The concentrate stream 11 flowing out of the separation zone 5 of the magnetic separator 1,1′,1″ is analyzed by a second measuring apparatus 10a in respect of at least one fluid parameter FP₁ from the group comprising:
a content of the concentrate stream 11 in terms of magnetic and/or magnetizable particles,
a content of the concentrate stream 11 in terms of non-magnetic and/or non-magnetizable particles,
a particle size and/or particle size distribution in the concentrate stream 11,
a solid content of the concentrate stream 11,
flow rate of the concentrate stream.

The fluid parameter FP₁ is transferred to a control device 16, which sends a control signal SW to the at least one drive unit 7,7′ as a function of the fluid parameter FP₁. The drive unit 7,7′ then effects a positioning of the at least one flow directing device 8,80 as a function of the measured fluid parameter(s) FP₁, wherein a setting value ST is prescribed for said flow directing device 8,80.

If e.g. the content in terms of magnetic and/or magnetizable particles in the concentrate stream 11 is captured as fluid parameter FP₁, the distance A between drum and fluid conduction arrangement is essentially preserved in the event that the content changes to more magnetic and/or magnetizable particles. If a change in the content to fewer magnetic and/or magnetizable particles in the concentrate stream 11 is measured, the distance A between drum and fluid conduction arrangement is decreased. This preferably takes place automatically. This ensures that the optimal separation performance can be maintained even in the context of changing fluid parameters FP₁, without having to turn off the magnetic separator 1,1,1″.

If e.g. the content in terms of non-magnetic and/or non-magnetizable particles in the concentrate stream 11 is captured as fluid parameter FP₁, in the event that the content changes to more non-magnetic and/or non-magnetizable particles, the distance A between drum and fluid conduction arrangement is increased and/or the flow directing devices are made to oscillate by the control device 16 and the drive device 7,7′, thereby causing a pulsation of the fluid and a breakdown of any flakes that may be present.

If a change in the content to fewer non-magnetic and/or non-magnetizable particles in the concentrate stream 11 is measured, the distance A between drum and fluid conduction arrangement is essentially preserved, provided a content in terms of magnetic and/or magnetizable particles remains constant. This preferably takes place automatically. This ensures that the optimal separation performance can be maintained even in the context of changing fluid parameters FP₁, without having to turn off the magnetic separator 1,1′,1″.

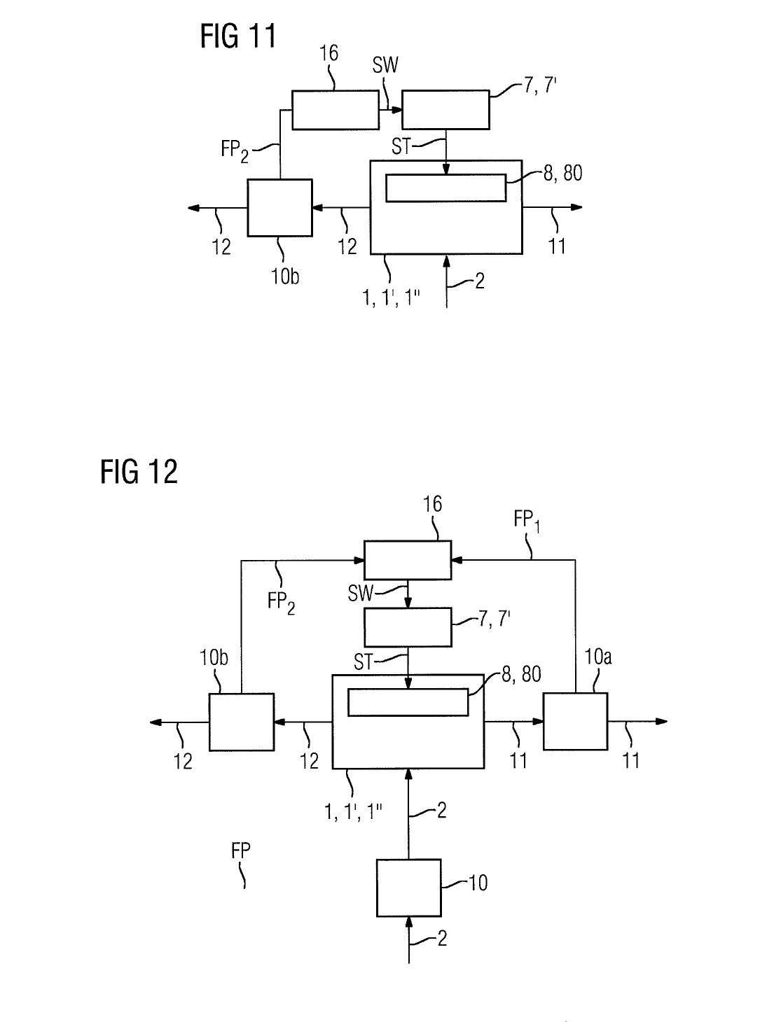

FIG. 11 shows a further schematic illustration of a preferred operation of a magnetic separator 1,1′,1″ comprising one or more flow directing devices 8,80. The waste stream 12 flowing out of the separation zone 5 of the magnetic separator 1,1′,1″ is analyzed here by a third measuring apparatus 10b in respect of at least one fluid parameter FP₂, for example:
the content of the waste stream 12 in terms of magnetic and/or magnetizable particles.

If the content in terms of magnetic and/or magnetizable particles in the waste stream 12 is captured as fluid parameter FP₂, the distance A between drum and fluid conduction arrangement is decreased in the event that the content changes to more magnetic and/or magnetizable particles.

If a change in the content to fewer magnetic and/or magnetizable particles in the waste stream 12 is measured, the distance A between drum and fluid conduction arrangement is essentially preserved.

This preferably takes place automatically. This ensures that the optimal separation performance can be maintained even in the context of changing fluid parameters FP₂, without having to turn off the magnetic separator 1,1′,1″.

FIG. 12 shows a further schematic illustration of a preferred operation of a magnetic separator 1,1′,1″. In this case, provision is concurrently made for a plurality of measuring apparatuses 10,10a,10b, which capture the fluid parameters FP,FP₁,FP₂ and transfer them to the control device 16. With respect to the functionality of measuring apparatuses 10,10a,10b, reference is made to the explanations for the FIGS. 9 to 11. Since a plurality of fluid parameters FP,FP₁,FP₂ which interact with each other are captured and analyzed here, provision must be made in the control device 16 for a suitable control algorithm which evaluates the fluid parameters FP,FP₁,FP₂ accordingly and automatically calculates the optimal positioning of the at least one flow directing device 8,80, said optimal positioning then being implemented by the drive device 7,7′. Such a control algorithm can readily be produced on the basis of a few test runs.

The FIGS. 1 to 12 merely show examples of magnetic separators according to the inventors proposals and operation thereof. Having knowledge of the proposals, a person skilled in the art is however easily able to provide further suitable magnetic separators and methods, without themselves having to exercise skill in this case. In particular, a multiplicity of further embodiments of flow directing devices and their arrangement in the region of the fluid conduction arrangement are possible.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

1-17. (canceled)

18. A magnetic separator for separating magnetic and/or magnetizable particles from a fluid which also contains non-magnetic and/or non-magnetizable particles, comprising:
a rotatable drum;
a magnet disposed in an interior of the rotatable drum;
a separation zone through which the fluid can be conducted, the separation zone disposed between the rotatable drum and a fluid conductor; and
a measuring apparatus for measuring a fluid parameter of the fluid,
wherein a modification is made to a distance between the rotatable drum and the fluid conductor and/or a width of the separation zone as a function of the fluid parameter.

19. The magnetic separator as claimed in claim 18, further comprising:
a flow directing device disposed in the fluid conductor; and
a drive device configured to move the flow directing device inwards into the separation zone.

20. The magnetic separator as claimed in claim 19, further comprising:
a control device configured to receive the fluid parameter and send a control signal to the drive device, the drive device configured to position the flow directing device as the function of the fluid parameter in response to the control signal.

21. The magnetic separator as claimed in claim 18,
wherein an angular range in which the distance between the rotatable drum and the fluid conductor or the width of the separation zone is configured to be modified is greater than 35° of a circumference of the rotatable drum.

22. The magnetic separator as claimed in claim 19, wherein a shape of the flow directing device is selected from the group consisting of a panel, a flap, a deflector plate, and a male form.

23. The magnetic separator as claimed in claim 19, further comprising:
a deformable membrane disposed on a surface of the fluid conductor proximate to the separation zone; and
the drive device being disposed on a surface of the membrane distal from the separation zone.

24. The magnetic separator as claimed in claim 19, wherein the drive device is selected from the group consisting of an electromotive drive, a pneumatic drive, a hydraulic drive, and a mechanical drive device.

25. The magnetic separator as claimed in claim 18, wherein the measuring apparatus is disposed proximate to an inlet of the fluid into the separation zone.

26. The magnetic separator as claimed in claim 18, wherein the fluid parameter is selected from the group consisting of:
a particle size and/or particle size distribution of the particles in the fluid,
a flow speed of the fluid,
a flow rate of the fluid,
a solid content of the fluid,
a content of a concentrate stream which has been separated from the fluid, in terms of magnetic and/or magnetizable particles and/or non-magnetic and/or non-magnetizable particles,
a particle size and/or particle size distribution of the particles in the concentrate stream or in a remaining waste stream after separation of the concentrate stream from the fluid,
a content of the waste stream in terms of magnetic and/or magnetizable particles and/or non-magnetic and/or non-magnetizable particles,
a flow rate of the concentrate stream, and
a solid content of the concentrate stream.

27. A method for operating the magnetic separator as claimed in claim 18, comprising:
conducting a fluid comprising magnetic and/or magnetizable particles and also non-magnetic and/or non-magnetizable particles through the separation zone;
accumulating the magnetic or magnetizable particles at the rotatable drum;
measuring the fluid parameter of the fluid using the measuring apparatus; and
modifying the distance between the rotatable drum and the fluid conductor or the width of the separation zone as the function of the fluid parameter.

28. The method as claimed in claim 27, further comprising:
modifying the distance between the rotatable drum and the fluid conductor or the width of the separation zone by modifying a position of a flow directing device using a drive device.

29. The method as claimed in claim 27, further comprising:
modifying the distance between the rotatable drum and the fluid conductor or the width of the separation zone automatically using a control device.

30. The method as claimed in claim 28, further comprising:
introducing an oscillation to the flow directing device using the drive device; and
modifying the distance between the rotatable drum and the fluid conductor or the width of the separation zone continuously in response to the oscillation.

31. The method as claimed in claim 30,
wherein an oscillation frequency or an oscillation amplitude or a temporal sequence of different oscillation frequencies or a temporal sequence of different oscillation amplitudes are set as the function of the fluid parameter.

32. The method as claimed in claim 27, wherein the fluid comprises a suspension.

33. The method as claimed in claim 27, further comprising generating a turbulent flow of the fluid in the separation zone.

34. The magnetic separator as claimed in claim 18, wherein the magnetic or magnetizable particles comprise ore and the non-magnetic or non-magnetizable particles comprise gangue.

35. The magnetic separator as claimed in claim 19, wherein the drive device moves the flow directing device towards the rotatable drum.

36. The magnetic separator as claimed in claim 18, wherein the measuring apparatus is disposed in the separation zone.

37. The magnetic separator as claimed in claim 18, wherein the measuring apparatus is disposed proximate to an outlet of the fluid from the separation zone.
